(19) United States
(12) Patent Application Publication
(10) Pub. No.: US 2010/0318964 A1
(43) Pub. Date: Dec. 16, 2010

(54) SOFTWARE EXTENSION ANALYSIS

(75) Inventors: Thomas A. Bouldin, Redmond, WA (US); Anderson K. Quach, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/483,600

(22) Filed: Jun. 12, 2009

(51) Int. Cl. G06F 9/44; G06F 9/34; G06F 12/02

(52) U.S. Cl. 717/120; 711/200; 711/E12.002

(57) ABSTRACT

Multiple structured extension definitions can be obtained, each structured extension definition corresponding to one or more categories, and each structured extension definition being written in a software extension language. Data representing one or more registrations maintained in a format native to a registration store can be accessed, and this data analyzed based at least in part on the multiple structured definitions. In other aspects, a structured extension definition written in a software extension language is obtained. The registration store includes registrations stored in a format native to the registration store and different from the software extension language, and the registration store is modified based on the obtained structured extension definition.

### BACKGROUND

A computer typically runs an operating system that provides various functionality including allowing other applications to be installed and run on the computer. Such an operating system oftentimes provides a location where applications, as well as the operating system, can store various types of information to be persisted across multiple executions of the applications. This location could be, for example, an operating system registry. However, problems can arise when storing such information because of the number of different programs that can access and modify the stored data. The manner in which such information is stored can change over time, and such changes are oftentimes not properly communicated to the different programs storing and/or retrieving the data. Accordingly, information can be easily stored improperly, which can result in instability that causes programs and/or the operating system to fail to operate properly.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, multiple structured extension definitions are obtained. Each structured extension definition corresponds to one or more categories, and each structured extension definition is written in a software extension language. Data representing one or more registrations maintained in a format native to a registration store are accessed, and this data is analyzed based at least in part on the multiple structured definitions.

In accordance with one or more aspects, a structured extension definition written in a software extension language is obtained. A registration store is modified based on the structured extension definition. The registration store includes registrations stored in a format native to the registration store and different from the software extension language.

### BRIEF DESCRIPTION OF THE DRAWINGS

The same numbers are used throughout the drawings to reference like features.

FIG. 1 illustrates an example computing device implementing the software extension analysis in accordance with one or more embodiments.

FIG. 2 illustrates an example format for structured extension definitions in accordance with one or more embodiments.

FIG. 3 is a flowchart illustrating an example process for implementing the software extension analysis in accordance with one or more embodiments.

FIG. 4 is a flowchart illustrating an example process for analyzing software extensions in accordance with one or more embodiments.

FIG. 5 is a flowchart illustrating an example process for inserting software extension registrations into a registration store in accordance with one or more embodiments.

FIG. 6 is a flowchart illustrating an example process for removing software extension registrations from a registration store in accordance with one or more embodiments.

FIG. 7 is a flowchart illustrating an example process for identifying a category of registration represented at a particular location in accordance with one or more embodiments.

FIG. 8 illustrates an example of a trie for structured extension definitions that can be used in accordance with one or more embodiments.

FIG. 9 illustrates an example computing device that can be configured to implement the software extension analysis in accordance with one or more embodiments.

### DETAILED DESCRIPTION

Software extension analysis is discussed herein. Native registrations have associated categories that are described in structured extension definitions, written in a software extension language. The native registrations are maintained in a store of a device, and can be analyzed as part of managing software extensions in the device. This managing can include various functionality, such as detecting problems in the native registrations, generating an inventory of registrations represented in the store, inserting registrations into the store in their native registration format, and removing all or portions of registrations from the store. Additionally, the structured extension definitions can be leveraged to determine, given a particular location in a store and at least a portion of the data in the store, the particular category of registration represented at that location.

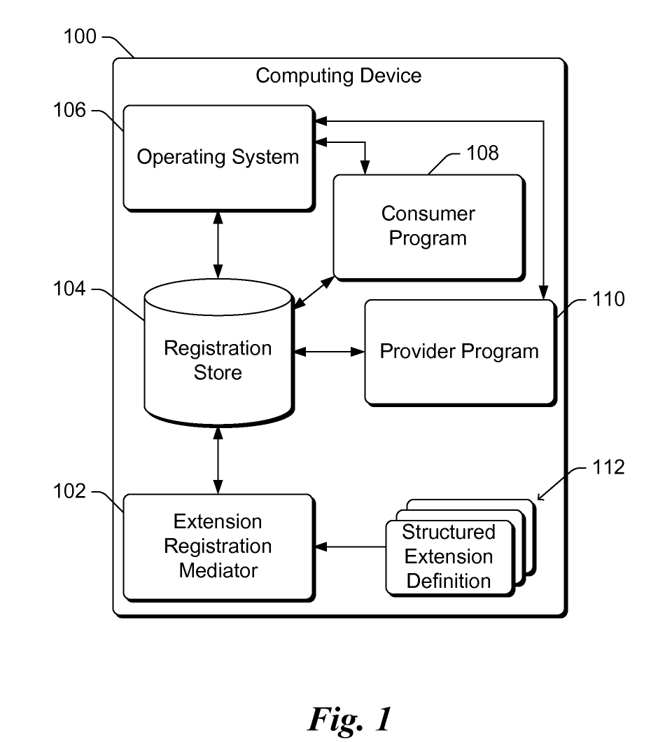

FIG. 1 illustrates an example computing device 100 implementing the software extension analysis in accordance with one or more embodiments. Computing device 100 can be a variety of different devices capable of running software and/or firmware programs. For example, computing device 100 can be a desktop computer, a laptop computer, a mobile station, an entertainment appliance, a set-top box communicatively coupled to a display device, a television, a cellular or other wireless phone, a personal digital assistant (PDA), a game console, an automotive computer, and so forth. Thus, computing device 100 can range from a full resource device with substantial memory and processor resources (e.g., personal computers, game consoles) to a low-resource device with limited memory and/or processing resources (e.g., traditional set-top boxes, hand-held game consoles).

Computing device 100 includes an extension registration mediator 102, a registration store 104, and an operating system 106. Operating system 106 manages the operation of software and/or firmware on computing device 100, including one or more consumer programs 108 and one or more provider programs 110. Operating system 106 itself is also typically implemented in software and/or firmware. Operating system 106 manages and maintains registration store 104, allowing programs 108 and 110 to store various information in and retrieve various information from registration store 104. One such registration store 104, handled by one or more embodiments, is an operating system registry.

Registration store 104 can store various data and setting information for programs 108 and 110 that is to be persisted across multiple executions of the programs. This data or setting information can include settings used by programs 108 and 110 when running, data to identify a particular program 110 that is to be run in response to certain events, data describing controls or other information that is to be displayed or otherwise presented while a program 108 or 110 is running, and so forth. Although one registration store 104 is illustrated in FIG. 1, alternatively two or more different registration stores 104 can be included in computing device 100. Programs 108 and 110 can access registration store 104 directly, or alternatively via operating system 106.

One particular type of data that is included in registration store 104 is native registrations (in addition to other non-registration data that can also be included in registration store 104 as discussed above). Provider programs 110 are able to provide various functionality when running, essentially allowing programs 110 to extend the functionality provided by consumer programs 108. The functionality can be extended in a variety of different manners using different types of categories. When a provider program 110 is installed on computing device 100, native registrations advertising the software extension functionalities provided by program 110 are stored in registration store 104. These native registrations can be stored in registration store 104 by provider program 110 (or an installer program that installs program 110 on computing device 100) directly, or alternatively via operating system 106.

For example, provider program 110 can indicate that it can interpret and provide functionality for managing a particular type of file (e.g., music files in a particular format, image files in a particular format, and so forth). During installation of provider program 110 on computing device 100, registrations indicating that that program 110 can interpret and provide functionality for managing that particular type of file can be stored in registration store 104 in the native registration format. After provider program 110 is installed, a consumer program 108 (or alternatively operating system 106) can activate the registration to gain the utility offered by provider program 110. Consumer program 108 can use operating system 106 to perform a task that relies on software extensions. For example, a web browser program can display a link to an email address. When a user clicks on the link, the web browser program asks operating system 106 to open the Uniform Resource Identifier (URI) for the email address (e.g., “mailto://name domain.com”). In response, operating system 106 activates the “mailto” registration of a “protocol” category.

It should be noted that, although consumer program 108 and provider program 110 are illustrated as separate programs, a single program can be both a provider program and a consumer program. Additionally, it should be noted that the operating system 106 can also be a consumer program and/or a provider program.

Extension registration mediator 102 can also access the native registrations stored in registration store 104 and analyze these native registrations to software extension management. Extension registration mediator 102 obtains structured extension definitions 112 that describe one or more categories which registrations conform to. These structured extension definitions 112 can be obtained from a variety of different sources, such as consumer program 108, a developer or distributor of consumer program 108, an actor or other entity on the behalf of consumer program 108, and so forth.

Each structured extension definition 112 describes one or more categories as they may be activated by a consumer program 108. The structured extension definitions 112 are implemented using a format or language known by extension registration mediator 102. However, this format or language is different from the native format that is used by registration store 104 in storing registrations. Accordingly, mediator 102 can assess the variety of categories represented in the structured extension definitions 112 and analyze the native registrations in registration store 104 based on those categories. Extension registration mediator 102 can thus compare what was published by the provider program (or by the developer of the provider program) and stored in registration store 104 to what is expected by consumer program 108 (as identified by definitions 112), and determine whether the native registration is conformant. Extension registration mediator 102 can also analyze the native registrations in registration store 104 based on the categories and generate an inventory of registrations.

In one or more embodiments, each structured extension definition 112 is an eXtensible Markup Language (XML) document written in accordance with a software extension language. This software extension language describes how a structured extension definition 112 is to be written so that the definition 112 can be used by extension registration mediator 102.

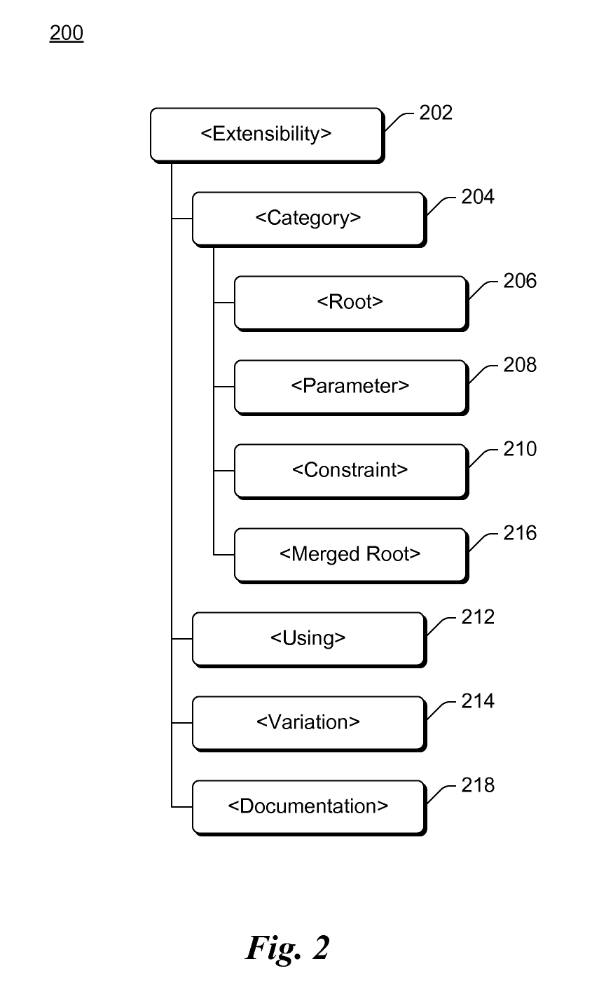

FIG. 2 illustrates an example format 200 for structured extension definition in accordance with one or more embodiments. Format 200 is a format used by an example software extension language, defining particular elements and attributes for the software extension language. Format 200 includes an extensibility element 202, a category element 204, a root element 206, a parameter element 208, a constraint element 210, a using element 212, a variation element 214, a merged root element 216, and a documentation element 218. A structured extension definition includes one extensibility element 202. Each extensibility element 202 can include one or more category elements 204. Each category element 204 can include zero or more root elements 206, one or more parameter elements 208, zero or more constraint elements 210, and zero or more merged root elements 216. Extensibility element 202 can also include zero or more using elements 212, zero or more variation elements 214, and zero or more documentation elements 218. It is to be appreciated that, in embodiments where structured extension definitions are XML documents, these elements 202-218 can also be referred to as tags.

Extensibility element 202 is an aggregation element that groups or aggregates together one or more categories (typically one or more categories that are logically related to one another). Each element 202 can also define various attributes, such as an indication of a particular program or programs that element 202 is designed to be compatible with, a range of versions of operating systems that element 202 is designed to be compatible with, and so forth.

Category element 204 defines the content of a registration and how native registrations are formed in a registration store. Category element 204 includes one or more parameter elements that define the data a registration may have, where it is stored, and what type it can be. Each category element 204 can also include various attributes. Table I includes an example of attributes that can be included in a category element. It is to be appreciated that the attributes in Table I are examples, and that alternatively other attributes can be included in a category element and/or one or more of the attributes in Table I can be excluded from a category element. Additionally, the various attributes (discussed here and elsewhere in this description) can be nested together and included as elements of a child tag rather than being included as an attribute.

TABLE I

| Attribute | Description |
|---|---|
| Name | The name of the category. |
| aggregated | Indicates whether registrations of the category can exist |
| | collectively (aggregated), or there only exists one |
| | registration per namespace. |
| instancesAre | Indicates whether registrations of this category are |
| | containers or leaves in the registration store in their native |
| | format. Leaves have data associated with them, whereas |
| | containers aggregate leaves and/or other containers. |
| store | Identifies a registration store 104 where the category is |
| | maintained. |
| blittable | Indicates whether registrations can be stored as native |
| | registrations by simple publishing logic. This is analogous |
| | to the programming concept of “blittable” or “plain old |
| | data” types, where a “blittable” registration can be expected |
| | to look the same on different types of systems. |
| architecture | Identifies one or more operating system architectures that |
| | the category is designed to be compatible |
| | with (e.g., a 32-bit architecture, a 64-bit |
| | architecture, the architecture of the |
| | current operating system is, the architecture of the provider, |
| | program and so forth). |

Root element 206 is an indication of a location in a store (e.g., registration store 104 of FIG. 1) where registrations for the category can be found in registration store 104. The format a registration takes inside registration store 104 is called a native registration. Root element 206 is, for example, a pathname identifying a location in the registry where native registrations for this category are stored. In one or more embodiments, a single native registration may exist in one or more of multiple namespaces in a registration store, each store contributing zero or more registration parameters. In this case, a merged root element 216 may identify the set of namespaces that cooperate to form a registration.

Parameter element 208 is a category parameter. Parameter element 208 includes data identifying a particular category parameter, the type of data that a corresponding registration parameter is to conform to, additional constraints upon the data that is allowed as a registration parameter, and instructions for how to derive this parameter from the native registration. In one or more embodiments, rules are used to infer these instructions when omitted. Different parameter elements identify the types of data that a registration of a category may contain. For example, a toolbar button category may have a parameter for buttonlcon of type ‘resource’ and a parameter of buttonText of type ‘description’. A registration for the toolbar button category is then allowed to include a buttonlcon of ‘myIcon.ico’ and buttonText of ‘click here’.

Parameter element 208 includes a name attribute that describes the parameter, as well as a use attribute indicating whether use of the element is optional. If use of the parameter is optional, then this parameter may be omitted from a registration. If use of the parameter is not optional, then a registration must have a registration parameter conforming to the category parameter in order to be a valid registration. Parameter element 208 can also optionally include a default value for the registration parameter.

Each parameter element 208 includes one parameter type that is the way a registration parameter is to be interpreted. Table II includes an example of parameter types that can be included in a parameter element. It is to be appreciated that the parameter types in Table II are examples, and that alternatively other parameter types can be included in a parameter element.

TABLE II

| Parameter Type | Description |
|---|---|
| boolean | A Boolean variable. |
| resource | Data for corresponding registration parameters is the path |
| | to a binary file and the ID of the resource to be loaded. |
| description | Data for corresponding registration parameters may be a |
| | resource of type string or a simple string. If the |
| | registration parameter is in the form of a resource, all |
| | operations or constraints of the data are performed on the |
| | loaded resource. |
| commandLine | Data for corresponding registration parameters are the |
| | path to a program and zero or more parameters that are to |
| | be provided to the program when invoking it. |
| string | Data for corresponding registration parameters is a string |
| | of characters. Optionally, values may be constrained to |
| | conform to a particular pattern defined by the category |
| | parameter type. |
| integer | Data for corresponding registration parameters is an |
| | integer in decimal, hexadecimal, or octal form. |
| | Optionally, minimum and/or maximum values |
| | may be enforced. |
| fileRef | Data for corresponding registration parameters is the path |
| | to a file or folder. |
| instance | Data for corresponding registration parameters is another |
| | whole registration. The category of this contained |
| | registration is specified by the category parameter. |
| reference | Data for corresponding registration parameters is the |
| | name of another registration on the system. The |
| | category of this referred registration is specified by |
| | the category parameter. |
| set | Data for corresponding registration parameters is zero or |
| | more values of an inner type. The inner type is specified |
| | by the category parameter. |
| enumeration | Data for corresponding registration parameters is one of |
| | any preordained values. The set of allowed values is |
| | specified by the category parameter. |

Constraint element 210 is a collection of one or more additional rules that the registration parameters are to follow in order to be valid registrations for the category. Constraint element 210 includes a name attribute that describes the constraint, a severity attribute indicating the severity of the constraint, and a rule element indicating the rule of the constraint. The severity of the constraint indicates how important the constraint is. Rules act upon registration parameters and other rules to produce a value. The rule of the constraint produces the value true in order for the registration to be valid. A violation of these rules or constraints when analyzing native registrations in registration store 104 (or at other times, such as when inserting a registration into store 104) can be recorded in a log, as discussed in more detail below. This recordation allows an administrator or other user to subsequently take appropriate actions as they see fit in response to these violations.

Using element 212 allows references to be made to definitions in another page (e.g., another structured extension definition). The using element includes a topic child element that identifies the other page which includes the definition. The using element also includes as child elements one or more category tags that can be referenced in this page (e.g., are included in this structured extension definition).

Variation element 214 allows a particular category to be overridden. The variation element includes an attribute that identifies the category being overridden, as well as one or more parameter elements that define the data a registration may have, where it is stored, and what type it is to be (analogous to a category element 204).

Merged root element 216 allows for per-namespace copies in a registration store. The merged root element 216 allows multiple namespaces to be combined or merged to form a registration. The merged root element 216 includes multiple children elements that identify the multiple namespaces being combined.

The documentation element 218 is a child of a parent element and describes the parent element, and can be a child of various elements 202-216. For example, as a child of a category element 204 the documentation element describes the purpose of the category. By way of another example, as a child of a parameter element 208, the documentation element describes the purpose of the parameter. By way of yet another example, as a child of a constraint element 210, the documentation element describes the purpose of/what is being checked by a constraint.

Returning to FIG. 1, it should be noted that, although illustrated as being part of the same computing device 100, one or more of extension registration mediator 102, registration store 104, and structured extension definitions 112 can alternatively be implemented on separate devices. For example, extension registration mediator 102 can be implemented on one computing device, while registration store 104 and operating system 106 are implemented on another computing device. In this example, structured extension definitions 112 can be on either of these computing devices, or alternatively on yet another computing device. By way of another example, registration store 104 can be implemented as a virtual image that is accessed by extension registration mediator 102 or registration store 104 can be implemented as the consequence to an actual registration store if some action were to be performed.

Structured extension definitions 112 can be obtained by extension registration mediator 102 in a variety of different manners. In one or more embodiments, a static discovery technique is used in which the structured extension definitions 112 are incorporated into extension registration mediator 102 when mediator 102 is compiled into executable code. In such embodiments, structured extension definitions 112 are incorporated into mediator 102, and mediator 102 is re-compiled each time a new structured extension definition 112 becomes available.

In other embodiments, a dynamic discovery technique is used in which the extension registration mediator 102 accesses a particular namespace, directly or through a data source, to identify where structured extension definitions 112 are located. This namespace can itself be the root of a category, discovered using the technique described in the above paragraph, or alternatively can take another form. During operation, extension registration mediator 102 accesses this particular namespace to identify where structured extension definitions 112 are located, then obtains the structured extension definitions 112 from the identified location. It is to be appreciated that mediator 102 can also access multiple layers or levels of namespaces in an analogous manner, such as accessing a first namespace that identifies a second namespace, which identifies a third namespace, and so forth until the namespace where the structured extension definitions 112 are located is accessed. In such embodiments, structured extension definitions 112 are obtained by mediator 102 during execution, so mediator 102 need not be re-compiled each time a new structured extension definition 112 becomes available.

Additionally, in one or more embodiments an interface module is included that operates as an interface between extension registration mediator 102 and registration store 104. This interface module (also referred to as a data source) can be included as part of extension registration mediator 102, as part of registration store 104, or alternatively as a separate module or component. This interface module is configured to accept commands or requests in a generic or homogenous form from extension registration mediator 102 and convert those commands or requests into commands or requests in a form specific to registration store 104. Different registration stores 104 can be implemented in different ways and/or support different types of communication. Different interface modules can be generated to communicate with these different registration stores 104, allowing the same extension registration mediator 102 to be used with these different registration stores simply by using the appropriate interface module.

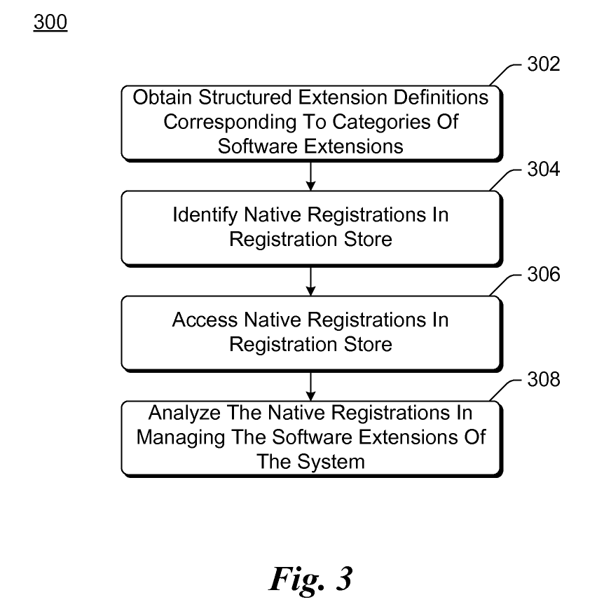

FIG. 3 is a flowchart illustrating an example process 300 for implementing the software extension analysis in accordance with one or more embodiments. Process 300 is carried out by an extension registration mediator, such as mediator 102 of FIG. 1, and can be implemented in software, firmware, hardware, or combinations thereof. Process 300 is an example process for implementing the software extension analysis; additional discussions of implementing the software extension analysis are included herein with reference to different figures.

In process 300, structured extension definition corresponding to categories of software extensions are obtained (act 302). As discussed above, these definitions can be obtained in a variety of different manners, including following dynamic and/or static discovery techniques.

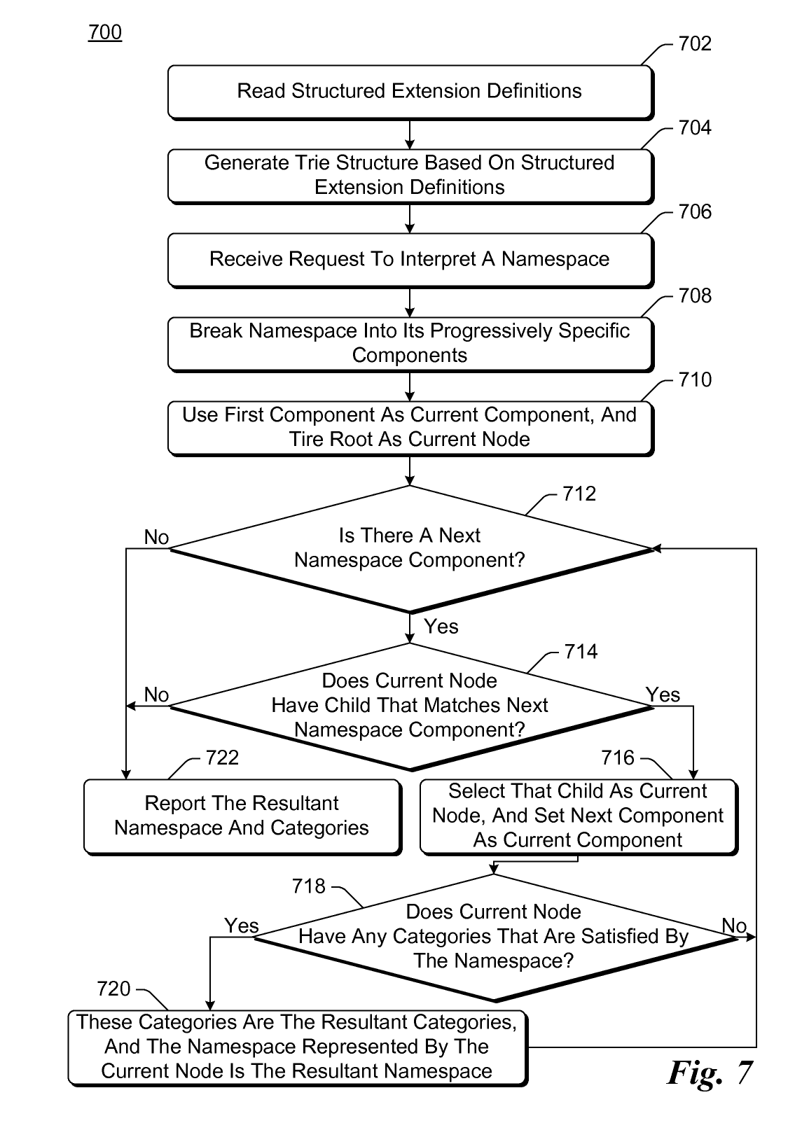

Native registrations in a registration store are identified (act 304) and accessed (act 306). As discussed above, this registration store can be implemented on the same device or system as the extension registration mediator implementing process 300, or alternatively on another device or system. A variety of different information can be included the registration store, including native registrations, software state, software settings, and so forth. The particular information in the registration store that are native registrations can be identified in act 304 in a variety of different manners. An example of one way in which the native registrations can be identified is discussed in more detail below with reference to FIG. 7.

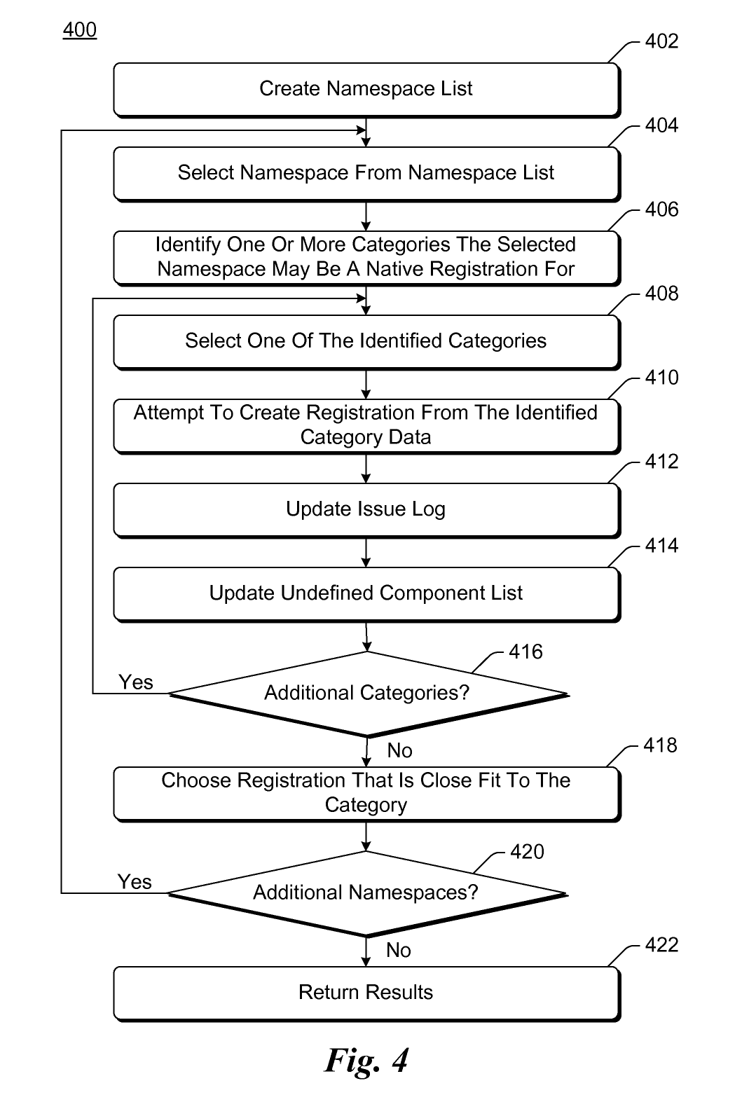

The native registrations accessed in act 306 are then analyzed in managing the software extensions of the system (act 308). This system in which the native registrations are managed is the system in which the registration store accessed in act 306 is implemented, which can be (but need not be) the same system as implements the extension registration mediator implementing process 300. This analysis can take a variety of different forms, including problem detection and/or inventory identification. Additional discussions of problem detection and inventory identification analyses are included below with reference to FIG. 4.

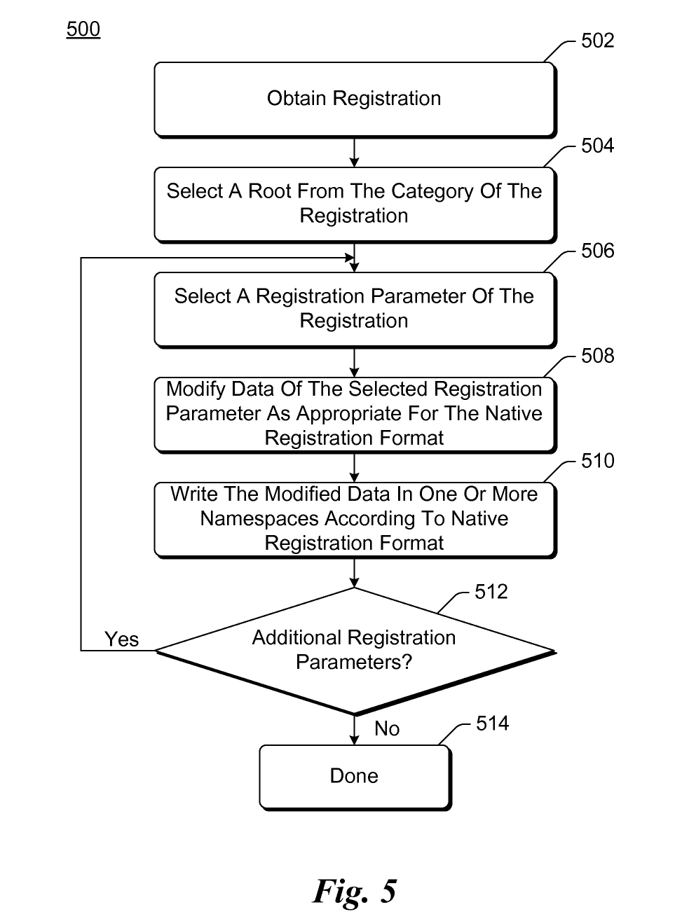

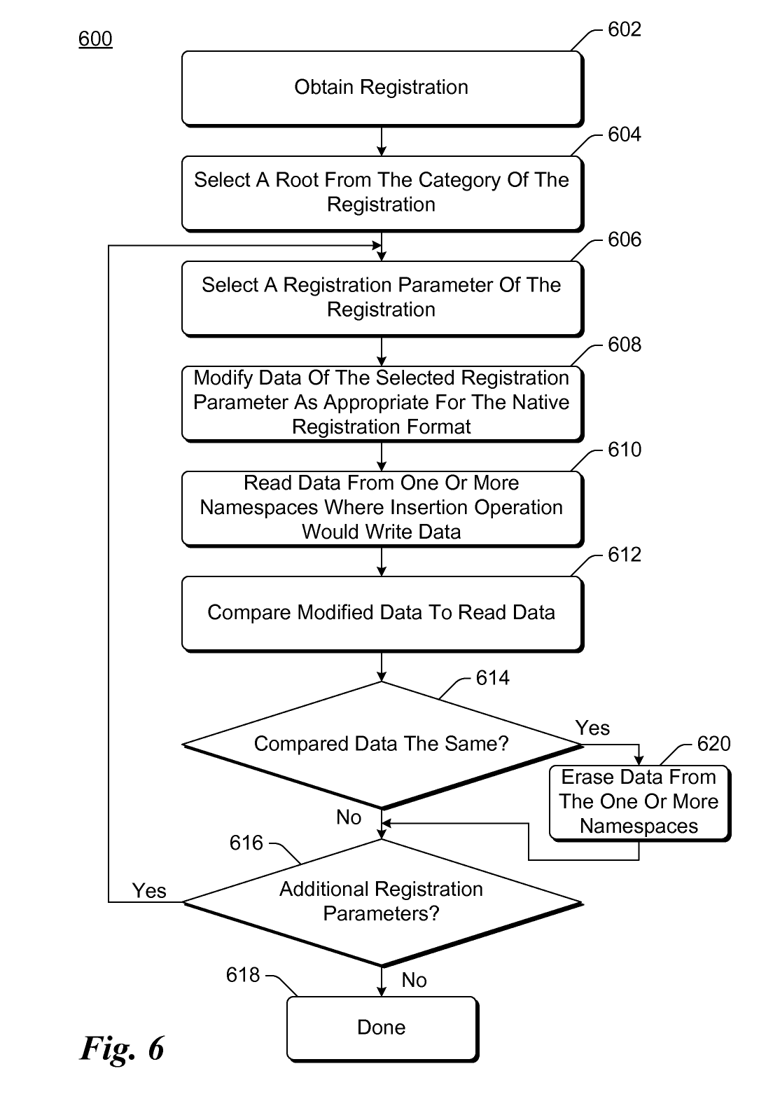

It should also be noted that, in addition to the analysis in act 308, other operations on the registration store or modifications to the registration store can also be performed. For example, software extension registrations can be inserted into the registration store and/or software extension registrations can be removed from the store. These insertion and removal processes are discussed in more detail below with reference to FIGS. 5 and 6. These insertion and removal processes can be performed in addition to acts 302-308 of FIG. 3, or alternatively can be performed independent of one or more of acts 302-308. For example, an insertion or removal process can be performed after acts 302-308 are performed. By way of another example, an insertion or removal process can be performed without acts 304 or 308 (and possibly act 306) being performed.

FIG. 4 is a flowchart illustrating an example process 400 for analyzing software extensions in accordance with one or more embodiments. Process 400 is carried out by an extension registration mediator, such as mediator 102 of FIG. 1, and can be implemented in software, firmware, hardware, or combinations thereof. Process 400 is an example process for analyzing software extensions; additional discussions of analyzing software extensions are included herein with reference to different figures. Process 400 is discussed with additional reference to FIG. 1.

In process 400, a namespace list is created (act 402). The namespace list is a list of the namespaces that category definitions suggest may be the namespace of a native registration. These category definitions are obtained from structured extension definitions 112. The namespace list created in act 402 can be a list of all the namespaces identified in the structured extension definitions 112, or a subset of all the namespaces identified in the definitions 112. In one or more embodiments, when the “aggregated” attribute of the category is set to true, then the namespaces in the namespace list are the children of those in the category. For example, the root is where registrations of the category are found, and if the registrations are aggregated then an element in that namespace is where one registration is found.

A namespace from the namespace list is selected (act 404). The namespace can be selected based on a variety of different criteria, such as according to an order of namespaces in the namespace list, alphabetically, randomly, and so forth.

One or more categories that the selected namespace may be a native registration for are identified (act 406). These categories can be identified in a variety of different manners. An example of one way in which the categories can be identified is discussed in more detail below with reference to FIG. 7.

One of the identified categories is selected (act 408). The category can be selected based on a variety of different criteria, such as according to an order in which categories are identified in act 406, alphabetically, randomly, and so forth.

An attempt is then made to create a registration from the data of the identified category (act 410). This attempt includes comparing the data of the identified category from the registration store to the structured extension definitions 112 and seeing how well the data of the identified category matches the structured extension definitions 112. For example, this attempt can include determining whether particular data identified in an extension definition as being mandatory is included in the category data, whether particular data identified in an extension definition as being optional is included in the category data, and so forth.

Based on the attempt in act 410, an issue log is also updated (act 412). This issue log is a listing indicating how well the category definition matches one or more of the extension definitions. This log can indicate, for example, that data identified as mandatory in the extension definition is missing from the category data, that a category parameter does not conform to a particular category parameter type identified in the extension definition, that the category data fails a particular constraint identified in the extension definition, and so forth.

Additionally, the issue log updated in act 412 can include an indication of a correlation between namespace components expected based on the extension definition but not found in the category data, and namespace components found in the category data but not defined in the category definition. This correlation can help identify, for example, minor problems (e.g., typographical errors) in the registrations represented in registration store 104. For example, a definition 112 can be compared to the category data in registration store 104 using any of a variety of different conventional techniques for determining a cost in transforming the namespace component expected according to definition 112 to the namespace component of data in the registration store (or vice versa). Such techniques can weight certain operations differently, such as removing characters or spaces, swapping characters, inserting characters, and so forth in order to generate a cost in transforming one to the other. Using such techniques, a largest possible cost of transforming a string of characters of the size of a namespace component identified in the structured extension definition 112 to a string of characters of the size of the namespace component in the registration store (or vice versa) is also determined. A value is then generated that is the cost of transforming the expected namespace component, according to definition 112, to the namespace component of unattributed data in registration store 104 divided by the largest possible cost of transforming a string of the one size to the other. The lower this generated value is, the closer the expected namespace component and the unattributed namespace component are to each other.

If this generated value is below a threshold value, then the namespace component identified in definition 112 and the namespace component in registration store 104 can be determined to be close enough that the namespace component is determined to be part of the path to one or more registration parameters. An indication of this determination is included in issue log 412.

An undefined component list is also updated (act 414). This undefined component list is a list of namespace components that were found in the extension definitions 112 but not defined by any category identified in act 406.

A check is then made in act 416 as to whether there are additional categories identified in act 406 that have not yet been selected in act 408. If there are additional categories that have been identified but not yet selected, then one of those categories is selected (act 408).

However, if each of the categories identified in act 406 has been selected in act 408, then a registration based on the extension definitions that is a close fit to the identified category is chosen (act 418). This close fit is based on the attempts in act 410. The close fit can be determined based on a variety of different criteria, such as one or more of the severity of issues identified and included in the issue log in act 412, the number of issues identified and included in the issue log in act 412, the number of issues that could possibly be included in the issue log in act 412, the number of namespace components included in the undefined component list in act 414, and so forth. These criteria can be used in a variety of different manners, such as selecting the category having the least severe issues identified in the issue log in act 412, the category having the fewest issues identified in the issue log in act 412, the category having a close correlation to the namespace component identified in the issue log in act 412, and so forth.

A check is then made in act 420 as to whether there are additional namespaces in the namespace list in act 402 that have not yet been selected in act 404. If there are additional namespaces that are in the namespace list that have not yet been selected, then one of those namespaces is selected (act 404).

However, if each of the namespaces in the namespace list created in act 402 has been selected in act 404, then results are returned (act 422). These results can take a variety of different forms, such as returning the registrations chosen in act 418, returning all or part of the issue log that is updated in act 412, returning all or part of the undefined component list that is updated in act 414, and so forth.

Process 400 can be used to provide a variety of different analysis of a registration store, including inventory identification and problem detection. For example, the registrations chosen in act 418 can be returned in act 422, which essentially results in an inventory of the registration store being returned in act 422. By way of another example, a single namespace can be analyzed by creating a namespace list in act 402 having a single namespace.

Process 400 can also support detection of various problems in the registration store. For example, the issues included in the issue log updated in act 412 for the category chosen in act 418 (or alternatively multiple categories) can be returned in act 422 as an error report for the registration store. By way of another example, a single namespace can be used in creating the namespace list in act 402, and the issues included in the issue log updated in act 412 for the category chosen in act 418 (or alternatively multiple categories) can be returned in act 422 as an error report for that single registration.

The results returned in act 422 can also optionally be displayed or otherwise presented by the extension registration mediator implementing process 400 and/or another component or module. For example, a notification of whether a problem was detected by process 400 can be displayed or otherwise presented or recorded by extension registration mediator 102. For example, an indication that a problem was detected with a particular native registration can be displayed to a user of computing device 100.

Additionally, the software extension language in which structured extension definitions are written can also be leveraged by extension registration mediator 102 in displaying or otherwise reporting detected problems. The analysis is based at least in part on the multiple structured extension definitions corresponding to the categories of one or more native registrations maintained in the registration store. Situations where the expectations described in the structured extension definitions are not met by the registration are identified and included in the issue log as discussed above in acts 410 and 412. These differences can be displayed to the user as a detected problem with the registration. Additionally, the structured extension definition can include different messages and/or annotations associated with different problems (e.g., that data identified as mandatory in the extension definition is missing from the category data, that a category parameter does not conform to a particular category parameter type identified in the extension definition, that the category data fails a particular constraint identified in the extension definition, and so forth). Based on the differences between the registration and the structured extension definition, one or more of these different messages and/or annotations can be identified and displayed, allowing a detected problem to be displayed in a manner that is more easily understood by users.

FIG. 5 is a flowchart illustrating an example process 500 for inserting software extension registrations into a registration store in accordance with one or more embodiments. Process 500 is carried out by an extension registration mediator, such as mediator 102 of FIG. 1, and can be implemented in software, firmware, hardware, or combinations thereof. Process 500 is an example process for inserting software extension registrations into a registration store; additional discussions of inserting software extension registrations into a registration store are included herein with reference to different figures. Process 500 is discussed with additional reference to FIG. 1.

In process 500, a registration is obtained (act 502). This registration can be obtained in a variety of different manners. In one or more embodiments, the registration can be a registration that is obtained as a result of analyzing a registration store of another device or system (e.g., performing process 400 of FIG. 4 on another device or system). Alternatively, the registration can be obtained in other manners. For example, a provider program 110, or another actor on the provider's behalf, can present extension registration mediator 102 with one or more registrations declaring the ability of provider program 110 to handle files of a particular type. These registrations define the operations provider program 110 can perform, how to request provider program 110 to perform the actions, and so forth.

A root from the category of the registration is selected (act 504). This root is a root of the namespace for the registration. Additionally, for aggregated categories (e.g., when the “aggregated” attribute of the category is set to true), the name of the registration is also selected.

A registration parameter from the registration is selected (act 506). The registration parameter can be selected based on a variety of different criteria, such as according to an order of registration parameters in the registration, according to a type of registration parameters, alphabetically, randomly, and so forth.

The data of the selected registration parameter is modified as appropriate for the native registration format (act 508). The extension registration mediator implementing process 500 is aware of the native registration format and of how to (or has access to information describing how to) convert data from a format used by the registration obtained in act 602 into a native registration. This can include, for example, adding or changing namespace components, converting characters of one type to another (e.g., the “\” character to the “|” character), and so forth.

The modified data is written into one or more namespaces according to the native registration format (act 510). The native registration format (known to or accessible to the extension registration mediator implementing process 500) can indicate that the data is to be written in one location, in which case the data is written to that one location in act 510. Alternatively, the native registration format can indicate that the data is to be written to multiple locations, in which case the data is written to those multiple locations in act 5 10.

A check is then made in act 512 as to whether there are additional registration parameters of the registration that have not yet been selected in act 506. If there are additional registration parameters that have not yet been selected, then one of those registration parameters is selected (act 506).

However, if each of the registration parameters of the registration has been selected in act 506, then process 500 is done (act 514). Thus, the extension registration mediator implementing process 500 stores each registration parameter for a registration in registration store 104 in the native registration format.

Returning to FIG. 1, the removal of system extension registrations refers to native registrations, or parameters thereof, stored in registration store 104 that match a registration. For example, if provider program 110 would like to stop advertising its ability to extend consumer program 108 (e.g., if provider program 110 were being uninstalled), provider program 110 or another actor on the provider's behalf can provide a registration to the software extension mediator to be removed from registration store 104. The software extension mediator would then remove the data from registration store 104 that comprises the native registration in the registration store.

In one or more categories with registrations residing in one or more registration stores, native registrations may obscure or override each other. In one or more embodiments, the removal algorithm may compensate for this behavior by verifying, per registration parameter, that the registration parameter's data matches (e.g., is equivalent to) the corresponding data in registration store 104 before removing that data from the store.

FIG. 6 is a flowchart illustrating an example process 600 for removing software extension registrations from a registration store in accordance with one or more embodiments. Process 600 is carried out by an extension registration mediator, such as mediator 102 of FIG. 1, and can be implemented in software, firmware, hardware, or combinations thereof. Process 600 is an example process for removing software extension registrations from a registration store; additional discussions of removing software extension registrations from a registration store are included herein with reference to different figures. Process 600 is discussed with additional reference to FIG. 1.

In process 600, a registration is obtained (act 602). This registration can be obtained in a variety of different manners, such as from a provider program 110 stop advertising its ability to extend consumer program 108.

A root from the category of the registration is selected (act 604). This root is a root of the namespace for the registration.

A registration parameter from the registration is selected (act 606). The registration parameter can be selected based on a variety of different criteria, such as according to an order of registration parameters in the registration, according to a type of registration parameters, alphabetically, randomly, and so forth.

The data of the selected registration parameter is modified as appropriate for the native registration format (act 608). As discussed above with reference to act 508 of FIG. 5, the extension registration mediator implementing process 600 is aware of the native registration format and of how to (or has access to information describing how to) convert data from a format used by the registration obtained in act 602 into a native registration.

Data is also read from one or more namespaces where an insertion operation would have written data (act 610). These namespaces are, for example, the one or more namespaces where modified data would be written for the registration in act 510 of FIG. 5, if the registration were being inserted into the registration store.

The modified data from act 608 is compared to the data that is read in act 610 (act 612), and a determination made as to whether the compared data in act 612 are the same (act 614). If the compared data are not the same, then a check is made in act 616 as to whether there are additional registration parameters of the registration that have not yet been selected in act 606. If there are additional registration parameters that have not yet been selected, then one of those registration parameters is selected (act 606).

However, if each of the registration parameters of the registration has been selected in act 606, then process 600 is done (act 618).

Returning to act 614, if the compared data are the same, then the data read from the one or more namespaces is erased (act 620). It is to be appreciated that the data from fewer than all of the namespaces from which the data is read in act 610 can be the same as the modified data from act 608, in which case only the data read in act 610 that is the same as the modified data from act 608 is erased in act 620. Thus, the extension registration mediator implementing process 600 erases or otherwise removes each registration parameter for a registration in registration store 104.

Process 600 is described with reference to the registration parameters being converted to the native registration format. Alternatively, registration parameters that are read in act 610 can be converted to the format used by the registration obtained in act 602.

In one or more embodiments, various aspects of the software extension analysis discussed herein can make use of a trie structure. A variety of different trie structures can be used with the software extension analysis discussed herein. Additionally, various other conventional tree structures can alternatively be used.

In accordance with one or more aspects, a category of registration represented at a particular location is determined based on a trie structure. Generally, the trie structure is generated from the namespaces and restrictions described in the structured extension definitions. Each trie node contains a progressively more specific namespace component than its parent and may point to zero or more categories for which native registrations are found at that namespace or, in some conditions, as the immediate children of the namespace. Each category may have zero or more additional restrictions upon namespaces that are to be met in order to be a native registration of the particular category. When trying to determine what category of registration (if any) data in a store represents, one or more of these nodes of the trie structure is checked to retrieve a set of categories that may accurately describe the data in the store. The data in the store is then compared to each of these categories, attempting to interpret the data as a registration parameter. The accuracy with which data in a store may be interpreted as registration parameters is used to heuristically choose zero or one category to interpret the data as. This process is discussed in more detail below.

FIG. 7 is a flowchart illustrating an example process 700 for identifying a category of registration represented at a particular location in accordance with one or more embodiments. Process 700 is carried out by a software extension mediator, such as mediator 102 of FIG. 1, which analyzes native registrations in a registration store, such as store 104 of FIG. 1. Process 700 can be implemented in software, firmware, hardware, or combinations thereof. Process 700 is an example process for identifying and extracting a native registration stored in a non-homogenous collection of data within a registration store 104; additional discussions of extracting registrations from data stored within a registration store are included herein with reference to different figures.

In the example of process 700, the registration store is implemented as one or more keys and values in a registry. The registry includes a hierarchy where one or more keys can be stored within another key. Additionally, zero or more values can be included in each key; these values have type (e.g., a numeral or text) and may have data. A native registration may exist as a single value or as the entire contents of a key. In some cases, a registration exists in the overriding union of the contents of more than one key. A single registration parameter is mapped to zero or more keys or values in the registry. A location in the registry is identified by a pathname, typically beginning with one of a preordained set of root keys, and including one or more key names through the registry hierarchy until the particular key is reached; a pathname for a value ends with the name of the value. Components of a path are separated with a delimiter character; in one or more embodiments, this delimiter character is ‘\’ although other characters can alternatively be used.

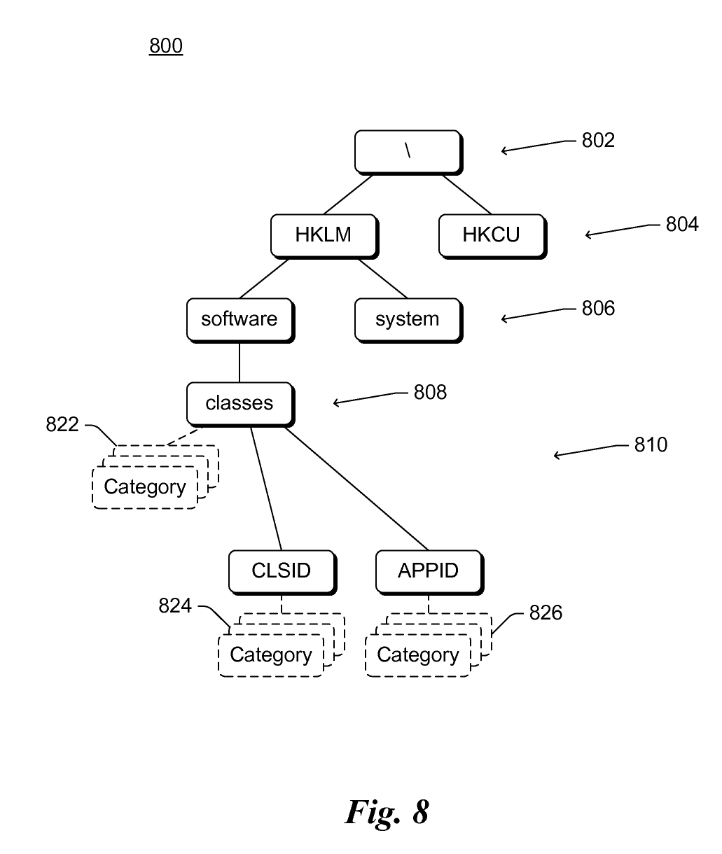

In process 700, the set of known categories that a particular namespace may represent a registration of is generated. The structured extension definitions (e.g., definitions 112 of FIG. 1) are read (act 702) and used to generate a trie structure (act 704). The structured extension definitions identify namespaces of the locations in the registration store, the registry in this example, where the native registrations are stored. These namespaces are used to generate a trie whose first children are the root keys in the registry and proceeding through one or more other keys. The trie includes a different node for each folder in the pathname. An example of such a trie is discussed in more detail below with reference to FIG. 8.

A category is associated with each node of the trie that represents the namespace of a root for the category. A single node holds an association with zero or more categories, and a record of this association can be maintained (e.g., by the module implementing process 700). Accordingly, given a particular node of the trie, zero or more categories associated with the namespace represented by that node can readily be identified. This association allows additional constraints categories place on the namespaces of their native registrations to be readily identified by namespace, and used as part of the identifying process 700 as discussed in more detail below.

A request to determine the possible categories which a namespace may represent a registration of is received (act 706). Such a request is also referred to as a request to interpret the namespace. The particular location is identified by a pathname. This request is typically received from another component or module running on the same device as implements process 700, although can alternatively be received from another device.

In response to the request, the namespace is broken into its progressively specific components (act 708). For example, if the namespace is HKLM\Software\Classes\, then the namespace is broken into its components of “HKLM”, “Software”, and “Classes”.

The first component from act 708 is used as a current component, and the root of the trie is used as a current node (act 710). For example, if the namespace is HKLM\Software\Classes\, then the current component in act 710 is “HKLM”. At this point, there is no current resultant namespace or resultant categories (e.g., the resultant namespace and resultant categories are set to null or some other value indicating they have not yet been identified).

A check is then made as to whether there is a next namespace component in the namespace (act 712). If there is a next namespace component in the namespace, then a check is made as to whether the current node has a child that matches the next namespace component (act 714). For example, if the namespace is HKLM\Software\Classes\, the current component is “HKLM”, and the current node is “HKLM”, then a check is made in act 714 as to whether the current node of the trie has a child that is “Software”.

If the current node does have a child that matches the next namespace component, then that child is selected as the current node, and the next component in the namespace is set as the current component (act 716). A check is then made as to whether the current node has any categories that are satisfied by the namespace (act 718). The current node has a category that is satisfied by the namespace if the current node has one or more categories that match (are the same as) the current component. For example, if the current node has a category of “FileAssociation”, which accepts children of the current namespace so long as they are containers that start with a period, and if the current node is “classes” with a child of “.mp3”, then the child of the current node has a category “FileAssociation” which is satisfied by the namespace represented by “.mp3”.

If the current node has any categories that are satisfied by the namespace, then those categories that are satisfied by the namespace are identified as the resultant categories and the namespace represented by the current node is identified as the resultant namespace (act 720). It should be noted that, for aggregated categories (e.g., when the “aggregated” attribute of the category is set to true), the check in act 718 and resultant categories in act 720 refer to the children of the namespace. For example, if “FileAssociation” has a root at HKLM\Software\Classes\, then a registration exists as the next key inside the namespace, and the categories of this registration are the categories referred to in acts 718 and 720.

Process 700 then returns to act 712 to check whether there is a next namespace component. If there is no next namespace component, then the resultant namespace and resultant categories are reported as the category or categories of registration represented at the particular location identified by the namespace (act 722).

Returning to act 718, if the current node does not have any categories that are satisfied by the namespace, then process 700 returns to act 712 to check whether there is a next namespace component. If there is no next namespace component, then the resultant namespace and resultant categories are reported as the category or categories of registration represented at the particular location identified by the namespace (act 722).

Returning to act 714, if the current node does not have a child that matches the next namespace component, then the resultant namespace and resultant categories are reported as the category or categories of registration represented at the particular location identified by the namespace (act 722).

It should be noted that situations can arise where act 720 is not performed, so the resultant namespace and resultant categories reported in act 722 are set to null or some other value indicating they have not yet been identified. It should also be noted that situations can arise where act 720 is performed multiple times for a namespace. In such situations, the categories and namespace most recently set in act 720 are reported in act 722.

In one or more embodiments, a determination is made as to how close a component of a namespace in the registration store is to a component described in the structured extension definition. This determination of closeness can be made by comparing the two namespace components using any of a variety of different conventional techniques for determining a cost in transforming one of the components to the other. Such techniques can weight certain operations differently, such as removing characters or spaces, swapping characters, inserting characters, and so forth in order to generate a cost in transforming one of the namespace components to the other. Using such techniques, a largest possible cost of transforming a string of characters of the size of one of the two namespace components to a string of characters of the size of the other of the two namespace components is also determined. A value is then generated that is the cost of transforming one of the components to the other divided by the largest possible cost of transforming a string of the one size to the other. The lower this generated value is, the closer the two components are to each other. If this generated value is below a threshold value, then the two pathnames can be determined to be close enough to be a mistake in the publishing of a native registration. Accordingly, if the generated value is below a threshold value, then the two pathnames can be viewed as the same (e.g., in act 714 it can be determined that the current node does have a child that matches the next namespace component even though the two may not be identical).

FIG. 8 illustrates an example of a trie 800 for structured extension definitions that can be used in accordance with one or more embodiments. Trie 800 can be, for example, a trie structure generated in act 704 of FIG. 7. Trie 800 includes multiple levels 802, 804, 806, 808, and 810. In each level are illustrated one or more nodes, such as “HKLM”, “HKCU”, “software”, “classes”, and so forth.

A root of the trie is at level 802, and has no value. Children of the root are illustrated at level 802, and represent the roots of all registration stores that extension registration mediator 102 of FIG. 1 knows how to analyze. Children of the namespace components at level 804 are illustrated at level 806, children of the namespace components at level 806 are illustrated at level 808, and so forth. The namespaces represented by the nodes in levels 804-810 are the names of the node and any parent nodes with a backslash between namespace components. For example, the node “classes” in level 808 represents the namespace “HKLM\software\classes”.

Each level can also 802-810 can also have associated with it one or more categories that are associated with the namespaces at that level. For example, level 808 can include one or more categories 822 that are associated with the namespace “HKLM\software\classes”. By way of another example, level 810 can include one or more categories 824 that are associated with the namespace “HKLM\software\classes\CLSID” and one or more categories 826 that are associated with the namespace “HKLM\software\classes\APPID”.

In one or more embodiments, when implementing a process for identifying a category of registration represented at a particular location, such as process 700 of FIG. 7, pathnames are stored as a pointer to an element in a trie structure. Each element or node of the trie (e.g., each key illustrated in FIG. 8) is stored in a particular memory location. As part of the process for identifying a category of registration represented at a particular location, pathnames are represented as pointers to the corresponding memory locations in the trie. For example, the node “classes” in level 808 would have a corresponding memory location, and the pathname “HKLM\software\classes” would be a pointer to that memory location corresponding to “classes”.

This representation of pathnames provides for efficient use of memory. Duplicate information need not be maintained for overlapping pathnames. Rather, simply the pointers to the correct memory locations can be maintained. Furthermore, a record of the number of pointers that exist to each memory location can be maintained. When the number of pointers to a particular trie location becomes zero, that location in the trie can be removed from memory (assuming that there are no pointers to children of that location in the trie).

Using this representation of pathnames as pointers to memory locations, equality of paths can be readily determined. If two pathnames are pointers to the same memory location, then the two pathnames are the same. However, if the two pathnames are pointers to different memory locations, then the two pathnames are not the same. This property also allows for an extremely efficient ordering or hashing; using the pointer to the node as a hash value, paths can be very efficiently stored as the key of an associative container.

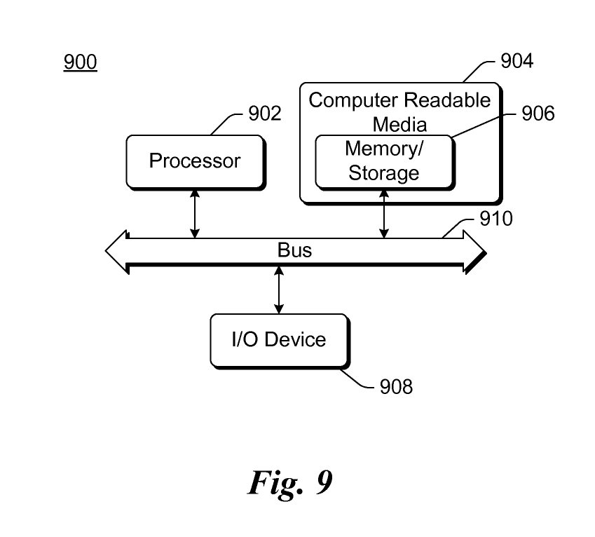

FIG. 9 illustrates an example computing device 900 that can be configured to implement the software extension analysis in accordance with one or more embodiments. Computing device 900 can be, for example, computing device 100 of FIG. 1.

Computing device 900 includes one or more processors or processing units 902, one or more computer readable media 904 which can include one or more memory and/or storage components 906, one or more input/output (I/O) devices 908, and a bus 910 that allows the various components and devices to communicate with one another. Computer readable media 904 and/or one or more I/O devices 908 can be included as part of, or alternatively may be coupled to, computing device 900. Bus 910 represents one or more of several types of bus structures, including a memory bus or memory controller, a peripheral bus, an accelerated graphics port, a processor or local bus, and so forth using a variety of different bus architectures. Bus 910 can include wired and/or wireless buses.

Memory/storage component 906 represents one or more computer storage media. Component 906 can include volatile media (such as random access memory (RAM)) and/or nonvolatile media (such as read only memory (ROM), Flash memory, optical disks, magnetic disks, and so forth). Component 906 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 902. It is to be appreciated that different instructions can be stored in different components of computing device 900, such as in a processing unit 902, in various cache memories of a processing unit 902, in other cache memories of device 900 (not shown), on other computer readable media, and so forth. Additionally, it is to be appreciated that the location where instructions are stored in computing device 900 can change over time.

One or more input/output devices 908 allow a user to enter commands and information to computing device 900, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module, functionality, or logic represents program code that performs specified tasks when executed on a processor (e.g., CPU or CPUs). The program code can be stored in one or more computer readable memory devices, further description of which may be found with reference to FIG. 9. The features of the software extension analysis techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer storage media having stored thereon multiple instructions that, when executed by one or more processors of a device, cause the one or more processors to:
obtain multiple structured extension definitions, each structured extension definition corresponding to one or more categories and each structured extension definition being written in a software extension language;
access data representing registrations stored in a format native to a registration store; and
analyze the data in the registration store based at least in part on the multiple structured extension definitions.

2. One or more computer storage media as recited in claim 1, the instructions further causing the one or more processors to:
generate a trie structure from the multiple structured extension definitions, the trie structure including a node for each namespace component in a pathname of each category in each structured extension definition;
receive a request to interpret data in a registration store as a registration;
check one or more of the nodes of the trie structure to determine a node corresponding to a namespace that satisfies the request; and
use categories corresponding to the node to identify the appropriate category of the registration.

3. One or more computer storage media as recited in claim 1, each namespace component in a pathname of each category in each structured extension definition having an associated memory location, and each pathname of a namespace component being referenced by a pointer to the associated memory location for the namespace component.

4. One or more computer storage media as recited in claim 1, wherein the analysis is based at least in part on the multiple structured extension definitions corresponding to the categories of one or more native registrations maintained in the registration store.

5. One or more computer storage media as recited in claim 1, wherein to analyze the one or more native registrations is to compare each of the categories associated with a namespace to corresponding data in the registration store and determine where the data in the registration store conforms to the rules defined by the category, resulting in the discovery of a registration in the format native to the registration store.

6. One or more computer storage media as recited in claim 1, wherein to analyze the data of a registration store is to generate a listing of registrations represented in the registration store.

7. One or more computer storage media as recited in claim 1, wherein to analyze the data of a registration store is to generate a list of issues with the native representations of registrations.

8. One or more computer storage media as recited in claim 1, wherein to access the data of a registration store is to access the registration store via an interface module that is configured to accept commands in one form and convert the commands to a form specific to the registration store.

9. One or more computer storage media as recited in claim 1, the instructions further causing the one or more processors to access one or more locations to identify where the structured extension definitions are stored, and obtain the structured extension definitions from the identified location.

10. One or more computer storage media as recited in claim 1, the registration store including, in addition to the registrations, non-registration data.

11. One or more computer storage media as recited in claim 1, wherein the multiple structured extension definitions are for a single namespace.

12. One or more computer storage media as recited in claim 1, wherein the multiple instructions further cause the one or more processors to identify one or more messages from the multiple structured extension definitions to be displayed in response to the analysis of the data detecting a problem in a registration in the registration store.

13. One or more computer storage media as recited in claim 1, wherein the software extension language defines:
one or more first elements each identifying data types for a category;
a second element identifying the one or more first elements; and
a third element indicating a location in the registration store where data for the category is stored.

14. A method implemented on a device, the method comprising:
obtaining a structured extension definition written in a software extension language; and
modifying a registration store based on the structured extension definition, the registration store including registrations stored in a format native to the registration store and different from the software extension language.

15. A method as recited in claim 14, further comprising:
converting data of one or more registration parameters of the structured extension definition into a native registration; and
the modifying the registration store comprising writing the converted data into one or more namespaces of the registration store.

16. A method as recited in claim 14, further comprising:
converting data of one or more registration parameters of the structured extension definition into a native registration;
reading data from a namespace of the registration store;
comparing the converted data to the read data; and
erasing the read data from the namespace of the registration store only if the converted data and the read data are the same.

17. A method as recited in claim 14, further comprising:
reading data from a namespace of the registration store;
converting the data into a same format as one or more registration parameters of the structured extension definition;
comparing the converted data to the one or more registration parameters; and
erasing the read data from the namespace of the registration store only if the comparing indicates the converted data and the one or more registration parameters are the same.

18. A method as recited in claim 14, wherein the software extension language defines:
one or more first elements each identifying data types for a category;
a second element identifying the one or more first elements; and
a third element indicating a location in the registration store where data for the category is stored.

19. A method as recited in claim 14, further comprising:
obtaining multiple additional structured extension definitions each corresponding to one or more categories and each being written in the software extension language;
accessing data representing registrations stored in the format native to the registration store; and
analyzing the data in the registration store based at least in part on the multiple additional structured extension definitions.

20. A method implemented in a device, the method comprising:
obtaining multiple structured extension definitions, each structured extension definition corresponding to one or more categories and each structured extension definition being written in a software extension language, the software extension language defining:
multiple parameter elements each identifying data types for one of the multiple categories,
a category element identifying the multiple parameter elements,
a root element indicating a location in a registration store where the data for the category is stored, and
a constraint element including one or more additional rules that the multiple registration parameters are to follow;
accessing one or more registrations represented in a registration store; and
analyzing the one or more registrations represented in the registration store in managing software extensions in the device.
